(19) United States
(12) Patent Application Publication
(10) Pub. No.: US 2011/0282721 A1
(43) Pub. Date: Nov. 17, 2011

(54) SYSTEMS AND METHODS FOR PROVIDING FUNCTIONAL ADVERTISEMENTS

(75) Inventor: Mike Dodson, Draper, UT (US)

(73) Assignee: IFAN MEDIA CORPORATION, Draper, UT (US)

(21) Appl. No.: 12/781,693

(22) Filed: May 17, 2010

(51) Int. Cl. G06Q 30/00; A63F 9/24; G06Q 10/00

(52) U.S. Cl. 705/14.14; 705/14.41; 705/14.52; 705/14.53; 705/14.69; 705/14.73; 463/42; 463/31

(57) ABSTRACT

One example embodiment includes a computing environment that includes an application for connecting a remote user to a client. The application performs a method of providing functional advertisements to the user. The method includes providing a functional advertisement, where the functional advertisement includes an advertisement that the user can interact with. The method also includes connecting a user to the client over a network and transmitting the functional advertisement from the client to a user over the network.

### CROSS-REFERENCE TO RELATED APPLICATIONS

This application is related to co-pending U.S. application Ser. No. ______, filed on May 17, 2010, and entitled, “SYSTEMS AND METHODS FOR PROVIDING INTERACTIVITY BETWEEN A HOST AND A USER”.

This application is related to co-pending U.S. application Ser. No. ______, filed on May 17, 2010, and entitled, “SYSTEMS AND METHODS FOR PROVIDING A SOCIAL NETWORKING EXPERIENCE FOR A USER”.

### BACKGROUND OF THE INVENTION

Social networking is becoming more popular as a tool allowing people to stay in touch with friends and family. It also is a powerful tool for users to find other people and groups with similar backgrounds and interests. Social networking gives users a chance to reach large audiences or small audiences depending on the interest of other users and the desires of the user. Social networking sites like Facebook and Twitter have gained huge numbers of users.

Nevertheless, many challenges remain in supplying robust social networking experiences. Many early adopters are unable to find large numbers of friends or acquaintances which leads them to, in turn, abandon the social networking site or visit only infrequently. Subsequent users may become disillusioned with the site because of the difficulty in finding others online or otherwise connecting with them. That is, until a critical mass of users join, many users of the social networking site simply fail to use the site regularly. Many social networking sites, therefore, have a large hurdle to overcome as they start up in enticing the required critical mass of users.

Additionally, users may become frustrated with having to load preferred applications or groups from the social networking website rather than loading the applications or groups directly. Sports fans, for example, may prefer to go directly to a sports group, rather than approaching the group through the main page of the social networking site. Although the fans can interact with other fans on the team's website or other designated areas, the ability to interact with specific members or discuss certain topics may be restricted, based solely on the site owner's preferences. Additionally, the team's website may make it difficult to locate friends using already built lists such as email contacts or Facebook friend lists.

Further, because the interactivity on team websites or social networking groups may be limited, it can be difficult for group members to interact during events of interest. For example, sports fans may wish to discuss a team's performance during a game. In particular, some sites allow for chat between individual members, but do not allow for chat groups which prevents users from interacting with a large number of other users. Additionally, viewers or listeners following the sporting event may not have access to a computer, which may be in a different location, such as a different room, to visit sites and interact with other fans. Many fans would be reluctant to leave the broadcast to check for or send messages to friends or other fans.

In addition, the fan experience may be somewhat diminished because of the inability of hosts or other event coordinators to receive feedback from fans in attendance or following via broadcast media. For example, a concert organizer may wish to hear from fans about what music fans would like to hear. Currently, however, the organizer must do polling well in advance and fans that are not planning to attend the concert may vote or provide feedback. This may provide a different result than if the organizer were able to receive feedback from only attendees or only a specific group of followers.

Accordingly, it would be advantageous for a social networking application to allow users to join in small groups and still provide a meaningful experience to users, allowing the application to more easily reach the necessary critical mass of followers. Additionally, it would be advantageous for users to easily find others who share in an interest in a particular subject and to simultaneously interact with users with whom they share a previous relationship such as family and friends. Further, it would be advantageous for a user of a social networking application to receive interactive content and communicate with other users and group organizers to provide meaningful feedback during an event.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a computing environment that includes an application for connecting a remote user to a client. The application performs a method of providing functional advertisements to the user. The method includes providing a functional advertisement, where the functional advertisement includes an advertisement that the user can interact with. The method also includes connecting a user to the client over a network and transmitting the functional advertisement from the client to a user over the network.

Another example embodiment includes a computing system comprising a processor and memory which stores one or more computer-executable components that when executed by the processor provides functional advertisements. The steps include connecting a user to a client over a network, where the user has utilized a multimedia device to connect to the network and transmitting real-time content over the network to the user, where the real-time content is configured to be published by the multimedia device as an audio signal or an image. The steps also include transmitting a functional advertisement from the client to the user, where the functional advertisement is configured to be published by the multimedia device and the functional advertisement is configured to be manipulated by the user. The steps further include receiving a response from the user.

Yet another example embodiment includes a system embodied on a computer-readable storage medium bearing computer-executable instructions that, when executed by a processor operatively coupled to memory on a computer that includes a client application for communicating with a remote computer, carries out a method for providing functional advertisements to a user. The system includes a processor, a monitor configured to display graphics to a user, a speaker configured to produce an audio signal that can be heard by the user and one or more computer readable media. The one or more computer readable media contain a set of computer-executable instructions. The set of computer-executable instructions is configured to connect a user to a client over a network where the client is an entity which presents content over the network and where the user is a consumer of the content presented by the client. The set of computer-executable instructions is also configured to receive the content over the network from the client, where the content includes real-time content intended to be consumed by the user at reception and functional advertisements that can be manipulated by the user allows the user to compete with other users for one or more prizes. The set of computer-executable instructions is further configured to publish the content, where publishing the content includes converting the content to an audio signal in the speaker or converting the content to graphics on the monitor. The set of computer-executable instructions is also configured to transmit a response from the user to the client over the network.

These and other objects and features of the present invention will become more fully apparent from the following description and appended claims, or may be learned by the practice of the invention as set forth hereinafter.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a block diagram of a system for allowing users to connect to one another and to an organization;

FIG. 2 illustrates a system that allows a user to run a client application;

FIG. 3 is a flow chart illustrating an example method for providing broadcast interactivity between a user and a host;

FIG. 4 is a flow chart illustrating an alternative method 400 for providing broadcast interactivity between a user and a host;

FIG. 5 illustrates an example of providing interactive content to a user;

FIG. 6 illustrates an example of the change in interactive content of FIG. 5 after being manipulated by the user;

FIG. 7 is a flow chart illustrating an example method for providing functional advertisements to a user;

FIG. 8 is a flow chart illustrating an alternative method for providing functional advertisements to a user;

FIG. 9 illustrates an example of a client application for providing a functional advertisement 905 to a user;

FIG. 10 illustrates an example of the functional advertisement of FIG. 9 after manipulation by the user;

FIG. 11 is a flow chart illustrating an example method for providing a social networking experience for a user;

FIG. 12 illustrates an example of a client application for connecting a first user to other users;

FIG. 13 is a flow chart illustrating an example method for providing a social media experience for a user;

FIG. 14 illustrates an example of a client application providing a social media experience for a user; and

FIG. 15 illustrates a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

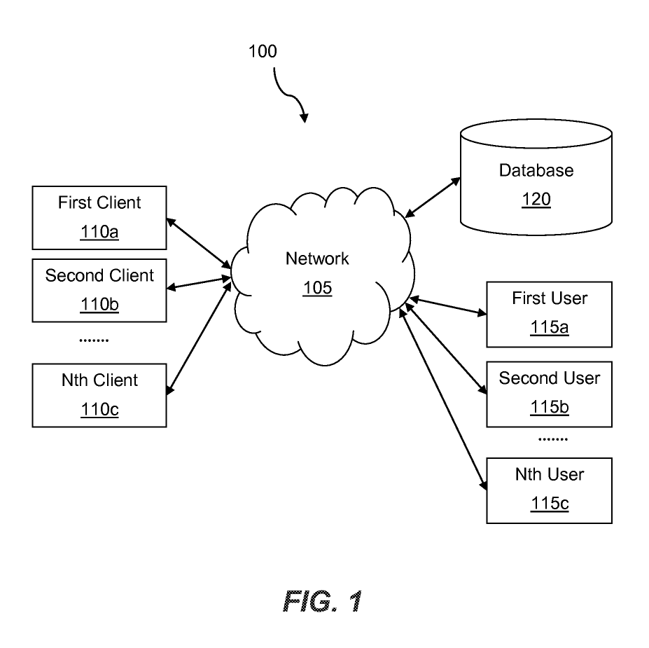

FIG. 1 illustrates a block diagram of a system 100 for allowing users to connect to one another and to a client. In at least one implementation, the system 100 can allow users to connect with other users, even if the users are connecting to or following different clients. Additionally or alternatively, the system 100 can allow users to connect with other followers of the client and with other users that share common interests or backgrounds.

FIG. 1 shows that the system 100 can include a network 105. In at least one implementation, the network 105 can be used to connect the various parts of the system 100 to one another. The network 105 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 105 includes one or more cellular RF networks and/or one or more wired and/or wireless networks such as, but not limited to, 802.xx networks, Bluetooth access points, wireless access points, IP-based networks, or the like. The network 105 can also include servers that enable one type of network to interface with another type of network.

FIG. 1 further shows that the system 100 can include one or more clients 110a, 110b and 110c (collectively “clients 110”). Although a first client 110a, a second client 110b and an Nth client 110c are shown in FIG. 1, the number of clients that can connect to the network 105 can include a single client 110a or any number of clients. That is, the number of clients that can be connected is without limit. In at least one implementation, the clients 110 can be any organization that desires to connect with one or more users. For example, the clients 110 can include a radio station. In particular, a radio station is an organization that broadcasts audio content. A radio station can include stations that broadcast in the AM or FM ranges of the radio spectrum. Additionally or alternatively, a radio station can include any organization that broadcasts audio programming over any network, including satellite radio, internet radio, short range radio broadcasts or any other programming that is intended to be received by the listener primarily as an audio signal.

A radio station can broadcast audio content. For example, the audio content can include music broadcasts. Music broadcasts include any broadcasts that primarily include music, although other content can be included as well. Additionally or alternatively, the audio content can include news radio, sports radio, talk radio or any other content which is intended to be consumed as an audio signal. In at least one implementation, a single radio station may broadcast different types of content at different times. For example, a radio station may broadcast syndicated talk shows for a certain period, followed by local news, followed in turn with sports content and can override normal broadcasts for sporting events, as desired. Therefore, the type of content should not be seen as limiting the invention, as described herein, unless otherwise specified in the claims.

In additional implementations, the clients 110 can include other organizations. In particular, the clients 110 can include sports teams, event venues, businesses, private clubs or any other organization intended to group individuals based on some common trait or preference. For example, the clients 110 can include professional or collegiate sports teams which want to allow fans to connect with one another. The organization can intend for users to interact continuously or to interact for the duration of an event. Therefore, the type of organization should not be seen as limiting the invention, as described herein, unless otherwise specified in the claims.

FIG. 1 also shows that the system 100 can include one or more users 115a, 115b and 115c (collectively “users 115”) connected to the network. In particular, the network 105 can allow the users 115 to connect to one or more of the clients 110 and to other users 115. In at least one implementation, users 115 can include any individual who desires to connect to clients 110 or other users 115 over the network. For example, the users 115 can include an individual who connects to listen to audio content from a radio station, a user who connects to follow a sports team and a user who connects to follow a political organization. One skilled in the art will appreciate, however, that a user 115 can connect to the network 105 for connection to any client 110 or user 115 without restriction and that users 115 can connect to several clients 110 simultaneously or at various times. Therefore, the content sought by the user 115 should not be seen as limiting the invention, as described herein, unless otherwise specified in the claims.

FIG. 1 also shows that the system 100 can include a database 120. In at least one implementation, the database 120 can store one or more client applications. In particular, the database 120 can store one or more client applications for each of the one or more clients 110. Users 115 can download the client applications from the database 120 over the network 105. One skilled in the art will appreciate that users 115 can download more than one client application from the database 120. For example, the first user 115a may download a client application from the first client 110a and the second client 110b. This can allow the first user 115a to connect with both the first client 110a and the second client 110b as desired.

In at least one implementation, the database 120 can be a centralized database from which all client applications are downloaded. Additionally or alternatively, each of the clients 110 can manage different databases, with users 115 downloading a client application from the desired client's database. For example, users 115 can navigate to web pages maintained by clients 110 and download the client applications directly. It should be noted that “Web Page” as used herein refers to any online posting, including domains, subdomains, Web posts, Uniform Resource Identifiers (“URIs”), Uniform Resource Locators (“URLs”), images, videos, or other piece of content and non-permanent postings such as e-mail and chat unless otherwise specified. One skilled in the art will appreciate, however, that any delivery system of the client application to the users 115 is within the scope of the invention. Therefore, the delivery method of the client application from the database 120 to the users 115 should not be seen as limiting the invention, as described herein, unless otherwise specified in the claims.

In at least one implementation, the first user 115a can connect with the second user 115b over the network 105 even if the first user 115a connects to the first client 110a and the second user 115b connects to the second client 110b. That is, each client application downloaded from the database 120 can allow users 115 to connect to one another regardless of which of the clients 110 the users 115 are individually connecting to. Accordingly, users 115 can connect with one another over the network 105 even if using different applications.

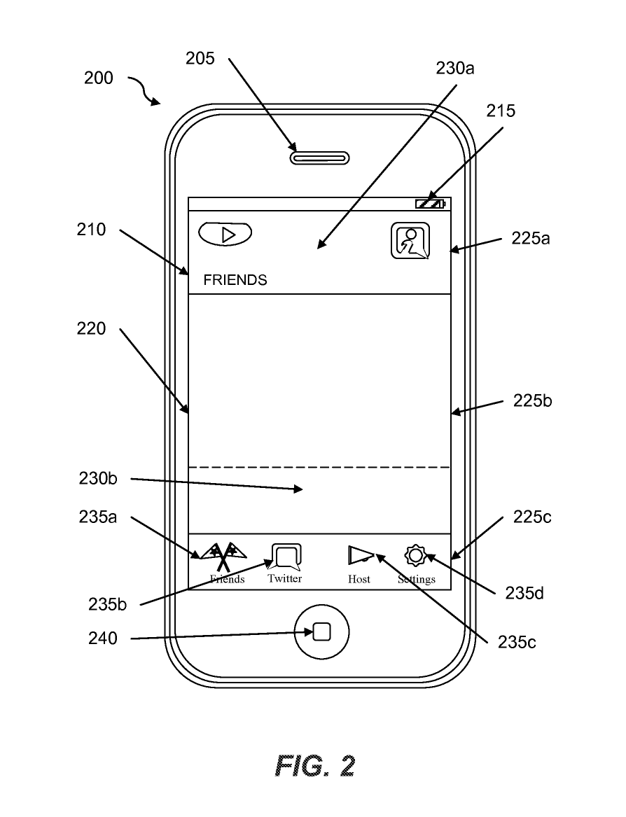

FIG. 2 illustrates a system 200 that allows a user to run a client application in accordance with an embodiment of the invention. In at least one implementation, the system 200 can include a multimedia device. Multimedia is media and content that uses a combination of different content forms. A content form is an encoded format for converting a specific type of data to displayable information. Multimedia can include text, audio, still images, animation, video, and interactivity content forms or any combination thereof. A multimedia device is any device that can access and playback multimedia content. In particular, multimedia devices can include set-top boxes, Blu-ray players, HDTVs, gaming consoles, cell phones, mobile devices and the like. One skilled in the art will appreciate, however, that any system capable of running the application is within the scope of the invention. Therefore, the system 200 should not be seen as limiting the invention, as described herein, unless otherwise specified in the claims.

FIG. 2 shows that the system 200 can include a speaker 205. In at least one implementation, the speaker 205 can include an electroacoustic transducer that converts an electrical signal into sound. Specifically, the speaker 205 can move in accordance with the variations of an electrical signal and causes sound waves to propagate through a medium. In particular, the speaker 205 can be used to produce sound from a data signal sent to the system 200. The speaker 205 can be part of the system 200 or can be an external device such as external speakers or headphones.

FIG. 2 also shows that the system 200 can include a monitor 210. In at least one implementation, the monitor 210 can include any device intended to produce images to be seen by a user. For example, the monitor 210 can include an electronic display. Specifically, an electronic display is a piece of electrical equipment which performs as output device for presentation of images transmitted electronically, for visual reception. In at least one implementation, the electronic display produces images without producing a permanent record. Additionally or alternatively, the electronic display can include one or more components intended to record the output signal.

FIG. 2 shows that the monitor 210 can display a number of images. For example, the monitor 210 can include a battery indicator 215 or other information regarding the state of the system 200. For instance, the monitor 210 can display information about the type of network connected to, the user signed in to the system 200, the operating software of the system 200 or other indicators of the status of the system 200.

FIG. 2 also shows that the monitor 210 can include a frame 220 for displaying application data. In at least one implementation, the frame 220 may be of a set size or set proportion of the monitor 210. Additionally or alternatively, the frame 220 can change size depending on the type or size of information to be displayed on the monitor 210. In at least one implementation, the frame 220 can be further divided into one or more subframes 225a, 225b and 225c (collectively “subframes 225”). The one or more subframes 225 can be used to display different content on the monitor 210 as directed by an application. One skilled in the art will appreciate that the content in the first subframe 225a can change without effecting the content in the second subframe 225b or third subframe 225c, and vice versa.

FIG. 2 further shows that the frame 220 can include one or more blank areas 230a and 230b (collectively “blank areas 230”). In at least one implementation, the blank areas 230 can be used for the placement of logos, advertisements or other content desired by the client. For example, the client could choose to permanently place a logo in the blank area 230a and sell the blank area 230b as advertising space. Additionally or alternatively, the client could choose to place logos in the blank areas 230b, sell both blank areas 230b as advertising space or keep both blank areas 230b as blank space. Blank areas 230 can allow a client to customize a pre-designed application.

FIG. 2 also shows that the frame 220 can include one or more tabs 235a, 235b, 235c and 235d (collectively “tabs 235”). In at least one implementation, the tabs 235 can allow a user to select different options within a client application. The number and types of tabs 235 can vary according to the options available. For example, one or more of the tabs 235 can be removed if the option is not currently available. For example, if the system 200 is not currently connected to a network or is otherwise unable to connect to other users.

FIG. 2 further shows that the system 200 can include one or more controls 240. In at least one implementation, the control 240 can configured to allow a user to control the system 200. For example, the control 240 can include a button or keyboard which allows a user to manipulate the system 200. Additionally or alternatively, the control 240 can include one or more electronic controls which appear on the monitor 210 as needed to allow the user to select temporary options based on the control needed in a particular piece of software. For example, the monitor 210 may include a touch screen device which allows additional controls to be displayed and selected. Additionally or alternatively, the control 240 can include a mouse or control wheel which allows a user to select menu options shown on the monitor 215 or otherwise control the system 200.

### I. Broadcast Interactivity

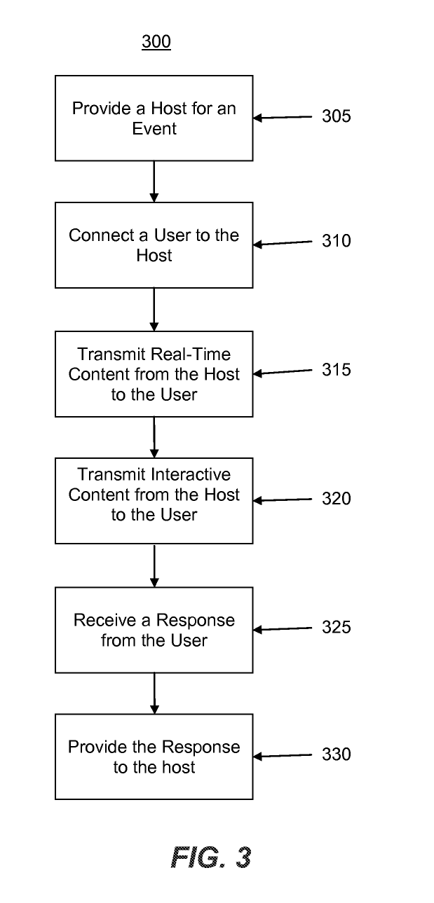

FIG. 3 is a flow chart illustrating an example method 300 for providing broadcast interactivity between a user and a host. In at least one implementation, the method 300 can be implemented using computer-readable media on a server or system being used by the host. One skilled in the art will appreciate that the method 300, as described herein, can be implemented in the systems of FIG. 1 and FIG. 2. Nevertheless, the method 300 is not limited to the systems of FIG. 1 and FIG. 2 but can be implemented in any system.

FIG. 3 shows that the method 300 includes providing a host for an event 305. In at least one implementation, a host can include a master of ceremonies, moderator, or interviewer for an event such as a television or radio program. For example, providing a host for an event 305 can include providing a broadcaster who narrates a sporting event on the radio. Additionally or alternatively, a radio host can be someone who introduces and discusses various genres of music, hosts a talk show that may take calls from listeners, or someone whose primary responsibility is to give news, weather, sports or traffic information. In at least one implementation, the event can include a sporting event, a political event, a radio show, a television show, and internet chat or any other event. For example, the event could include a sporting event with a sports host.

FIG. 3 also shows that the method 300 includes connecting a user to the host 310. In at least one implementation, connecting a user to the host 310 includes producing a network connection between a device being used by the host and a device being used by the user. The connection can allow content to be directed in one-way or two-way traffic or can be used to limit the type of traffic that travels in a particular direction. For example, the connection can allow the host to publish information to the user as graphics, video or text but allow the user to respond using only text. The device used by the user can include any device capable of connecting to a network, such as a multimedia device, a computer, a cell phone or any other device that provides the necessary connection.

FIG. 3 further shows that the method 300 includes transmitting real-time content from the host to the user 315. In particular, transmitting real-time content from the host to the user 315 can occur over the network connecting the user to the host. Additionally or alternatively, transmitting real-time content from the host to the user 315 can occur over a different network than the one connecting the user to the host. For example, the user and host can be connected via the internet whereas the real-time content is broadcast as part of a radio transmission. In at least one implementation, the real-time content can include audio or video components. For example the real-time content can include a radio or television broadcast.

FIG. 3 also shows that the method 300 includes transmitting interactive content from the host to the user 320. In at least one implementation, interactive content is content that is related to the content broadcast by the host. In particular, the content can include text or images related to an occurrence being discussed. For example, the interactive content can include images or text related to a topic being discussed during a radio broadcast. During a sports contest, a radio host may wish to transmit an image of a play that occurred and is being discussed or transmit the wording of a rule if a foul is being discussed.

Additionally or alternatively, the interactive content can include content that can be manipulated by the user. In at least one implementation, the interactive content can be more permanent than other content. For example, the interactive content can include an image of a sports play. The user can then save the image or forward the image to other users or save the image. In contrast the real-time content can be more ephemeral or protected such that the user cannot forward or save the real-time content.

In at least one implementation, the host can intend the interactive content for a single user or group of users. For example, the users could be able to set preferences for what types of interactive content to access. In particular, some users using cell networks or other networks that charge based on the amount of data traffic may wish to block content that includes a large amount of data. Additionally or alternatively, the host can customize the users for which the interactive content is intended. For example, the host can intend the interactive content to be received by all users, all connected users, users that fit a certain demographic profile, or users that are within a particular profile. For example, the interactive content can include a text file that is intended for all users, whether currently online or to be accessed in the future.

In at least one implementation, the host can provide interactive content to the user based on the geographic position of the user. For example, the user could receive the interactive content only if the user is within a defined geographic area. Additionally or alternatively, the interactive content could be transmitted to a first user in a first geographic area and a second interactive content could be transmitted to a second user in a second geographic area. The second geographic area can be designated as any geographic area not in the first geographic area, or could include a geographic area that is defined irrespective of the first geographic area.

FIG. 3 further shows that the method 300 includes receiving a response from the user 325. In at least one implementation, receiving a response from the user 325 can include receiving information requested from the user by the host. For example, the interactive content can include a poll and the response can include the user's response to the poll. Additionally or alternatively, receiving a response from the user 325 can include receiving unprompted responses from the user such as chat comments or text messages.

FIG. 3 also shows that the method 300 includes providing the response to the host 330. In at least one implementation, providing the response to the host 330 can include providing the original response. For example, providing the response to the host 330 can include a question for the host in response to the host selecting one user to provide a question. Additionally or alternatively, providing the response to the host 330 can include providing the combined responses from multiple users to the host. For example, the host can be provided with the combined poll results of all users.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

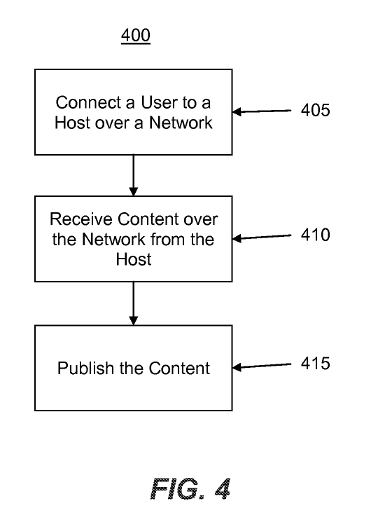

FIG. 4 is a flow chart illustrating an alternative method 400 for providing broadcast interactivity between a user and a host. In at least one implementation, the method 400 can be implemented using computer-readable media on a user's multimedia device. One skilled in the art will appreciate that the method 400, as described herein, can be implemented in the systems of FIG. 1 and FIG. 2. Nevertheless, the method 400 is not limited to the systems of FIG. 1 and FIG. 2 but can be implemented in any system.

FIG. 4 shows that the method 400 includes connecting a user to a host over a network 405. In at least one implementation, the host is an individual who presents content over the network. For example, the host can include a radio or television broadcaster. Additionally or alternatively, the host can include a chat moderator or any other individual who is controlling the amount and type of content presented to a user. In at least one implementation, the user is a consumer of the content presented by the host. For example, if the host is a radio broadcaster, a user is one who listens to the radio broadcast.

FIG. 4 also shows that the method 400 includes receiving content over the network from the host 410. In at least one implementation, the content includes real-time content. Specifically, the content can include a broadcast or other ephemeral content that is meant to be converted by a system into a sensory signal rather than being saved by the system, such as an audio broadcast. One skilled in the art will appreciate that the real-time content can be saved by the user, whether the intent is to be consumed in real-time or not. In particular, the content can include an audio component, even if the content includes other material. For example, a television broadcast includes an audio and video component. Additionally or alternatively, the content can include text, video, graphics or any other type of content.

In at least one implementation, the content also includes interactive content. In particular, the interactive content is related to the real-time content. For example, a radio station can broadcast live from a store and the interactive content can include material about the store, such as maps to the store or coupons that can be redeemed at the store. In at least one implementation, the interactive content can allow a user to respond to the host. For example, the host can publish a questionnaire and the user can be allowed to respond to the questionnaire. Additionally or alternatively, the user can forward the interactive content to other users or save the interactive content.

FIG. 4 further shows that the method 400 includes publishing the content 415. In at least one implementation, publishing the content 415 includes converting an electrical signal, either digital or analog, to a sensory signal that can be perceived by the user. For example, publishing the content 415 can include converting the content to an audio signal in the speaker. Additionally or alternatively, publishing the content 415 can include converting the content to graphics on the monitor. One skilled in the art will appreciate that publishing the content 415 includes any conversion of the content which allows the content to be perceived by the user.

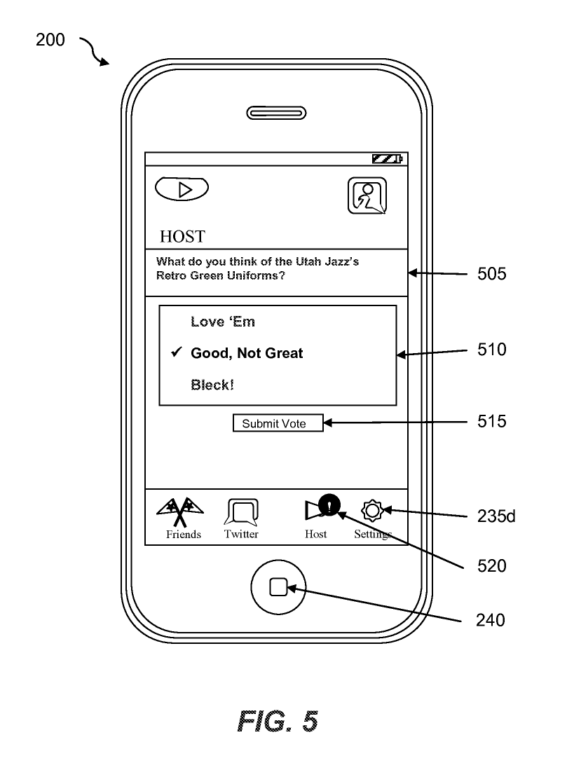

FIG. 5 illustrates an example of a client application 505 providing interactive content to a user. The interactive content can include a graphic. For example, the graphic can include a video clip, an audio clip, a URL, an image, an advertisement with a link to content supported by the advertiser, an instant poll or any other content that the host can send to the user. In at least one implementation, the interactive content can be published to the user during a real-time broadcast. For example, the interactive content can be published to the user during a radio or television broadcast. Additionally or alternatively, the interactive content can be published to the user without an accompanying broadcast. For example, the client can publish the content at a set time or prior to an event. For example, the client could publish special offers or a poll about an upcoming event.

In at least one implementation, a user can set preferences to allow or block the interactive content. For example, the user can select the settings tab 235d to change the settings and allow or block all interactive content or certain types of interactive content. Additionally or alternatively, the interactive content can prompt a text box which allows the user to accept the interactive content.

FIG. 5 shows that the interactive content can include a poll 505. In at least one implementation, the poll 505 can be a question with multiple choice answers for the user to select from. Additionally or alternatively, the poll 505 could be open ended with the user typing their own answers. The poll 505 could be intended to elicit the opinion of one user or a selected group of users. For example, a sports team could send the poll 505 to season ticket holders, to attendees of a particular game or to another group of fans.

FIG. 5 also shows that the poll 505 can allow the user to select from among multiple-choice answers 510. In at least one implementation, the user can select from the multiple-choice answers 510 using the control 240. Additionally, or alternatively, the user can select from the multiple-choice answers 510 using a touch screen, a mouse or the like. One skilled in the art will appreciate that the number and type of options available to the user will be based on what type of interactive content is published.

FIG. 5 further shows that the interactive content can include a button 515 for submitting a reply to the poll 505. In at least one implementation, the user needs to submit a reply before viewing the results of the poll 505. Additionally or alternatively, the interactive content can include other options. For example, the poll 505 could include a second button that allows the user to view the results without submitting a vote or a cancel button to leave the poll 505 without voting or viewing the results. One skilled in the art will appreciate that the button 515 can be modified in any fashion as required by the interactive content.

FIG. 5 also shows that the interactive content can provide a notification 520 if new interactive content is available from the host. In at least one implementation, the notification 520 can be displayed, even if the interactive content is brought up immediately, i.e., if the content is displayed on the monitor without prompting the user for permission. Additionally or alternatively, the notification 520 can be removed as soon as the interactive content is displayed. One skilled in the art will appreciate that the behavior of the notification 520 can be set by the client or can be changed by the user using the setting icon 235d or through some other method.

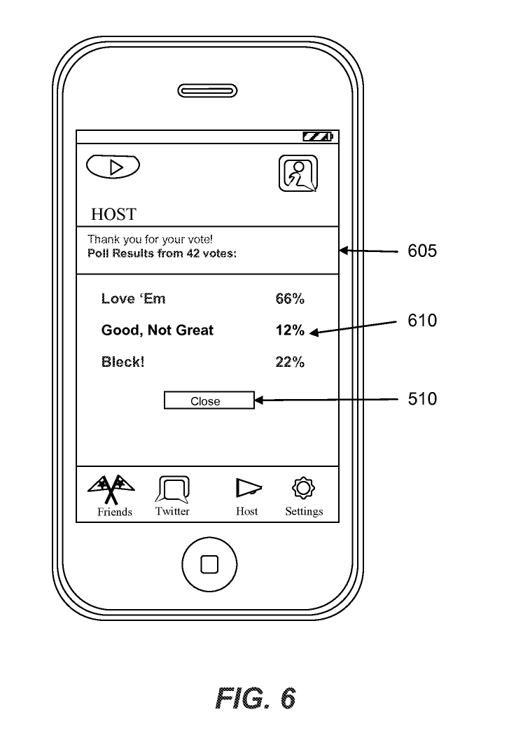

FIG. 6 illustrates an example of the change in interactive content 605 of FIG. 5 after being manipulated by the user. FIG. 6 shows that the text of the interactive content 605 has changed to reflect the fact that the user has submitted a result to the poll question 505 of FIG. 5. In at least one implementation, after voting the in the poll, the user can receive results, such as results 610 and see how other users have voted. One skilled in the art will appreciate that the host can also be given access to the results.

FIG. 6 further shows that the button 515 has changed to provide different options to the user. For example, since the interactive content 600 shows that the user has voted and is receiving results, the button 515 gives the user the option of closing the interactive content. The notification 520 of FIG. 5 can also be removed to indicate that the user has accessed the interactive content 600.

### II. Functional Advertising

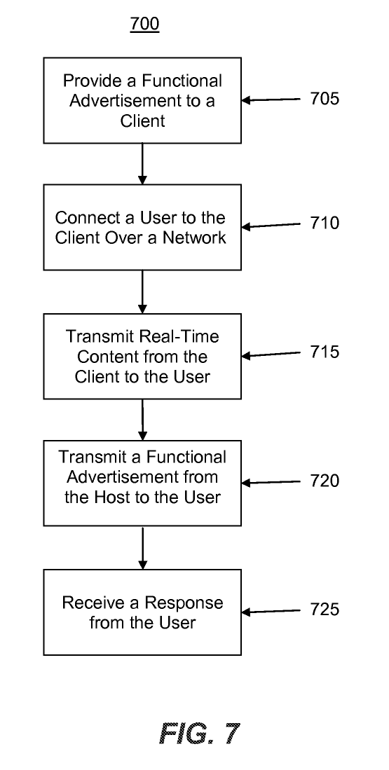

FIG. 7 is a flow chart illustrating an example method 700 for providing functional advertisements to a user. In at least one implementation, an advertisement is a form of communication intended to persuade an audience (viewers, readers, listeners or others who are consuming content) to take some action. In particular, an advertisement includes the name of a product or service. Additionally or alternatively the advertisement includes information about how that product or service could benefit the consumer, to persuade potential customers to purchase or to consume that particular brand.

In at least one implementation, a functional advertisement is an advertisement that seeks to entertain or provide services to a user, or otherwise allows the user to interact with the advertisement, in return for increased exposure to the advertiser's name or products. In particular, a functional advertisement can include a game or that the user can play or another type of entertaining activity. For example, the functional advertisement can include a contest that relates to the client that the user has connected to, such as a score prediction contest if the client is a sports team. Additionally or alternatively, the game can include an outcome prediction contest, where the user predicts the outcome of one or more contests or a player performance prediction contest where the user predicts how one or more players will perform in one or more contests. Other examples include a scored game, where the user competes with other users to achieve a high score or a geographic game where the user must visit one or more geographic locations.

Additionally or alternatively, the functional advertisement could include a service that benefits the user. For example, the functional advertisement could include a coupon service that allows the user to find coupons or other special deals for the advertiser's product. One of skill in the art will appreciate that a functional advertisement can include any advertisement that is meant to provide some benefit to the user unless otherwise stated in the claims.

FIG. 7 shows that the method 700 includes providing a functional advertisement 705. In at least one implementation, providing a functional advertisement 705 includes the client developing and producing a functional advertisement. Additionally or alternatively, providing a functional advertisement 705 includes a developer producing the functional advertisement for the client. For example, if a number of different clients use the same network and family of applications for connecting to users, the developer of the network or applications can produce a single functional advertisement that can be customized by each client to suit their particular needs, as discussed below.

FIG. 7 also shows that the method 700 includes connecting a user to the client over a network 710. In at least one implementation, connecting a user to the host 710 includes producing a network connection between a device being used by the host and a device being used by the user. The connection can allow content to be directed in one-way or two-way traffic or can be used to limit the type of traffic that travels in a particular direction. For example, the connection can allow the host to publish information to the user as graphics, video or text but allow the user to respond using only text. The device used by the user can include any device capable of connecting to a network, such as a multimedia device, a computer, a cell phone or any other device that provides the necessary connection.

FIG. 7 further shows that the method includes transmitting real-time content from the client to the user 715. In particular, transmitting real-time content from the client to the user 715 can occur over the network connecting the user to the client. Additionally or alternatively, transmitting real-time content from the client to the user 715 can occur over a different network than the one connecting the user to the client. For example, the user and client can be connected via the internet whereas the real-time content is broadcast as part of a radio transmission. In at least one implementation, the real-time content can include audio or video components. For example the real-time content can include a radio or television broadcast.

FIG. 7 also shows that the method 700 includes transmitting a functional advertisement from the host to the user 720. In at least one implementation, the functional advertisement can relate to the content broadcast by the host. In particular, the functional advertisement can include a game or other activity related to the real-time broadcast. For example, the functional advertisement can include a service that allows an event attendee to order refreshments for an upcoming intermission or break. The service could allow the user to bypass long lines and quickly pick-up the refreshments by allowing the user to pre-order and pay for the refreshments.

FIG. 7 further shows that the method 700 includes receiving a response from the user 725. In at least one implementation, receiving a response from the user 725 can include receiving information requested from the user. For example, the functional advertisement can include a score prediction contest and the response can include the user's response to the contest or information on the user's refusal to respond. For example, if the user normally connects the client on a cell phone and normally responds to the score prediction contest, the response can include information about the user's activities, such as a phone call, that will allow the client to better configure the functional advertisement to the user's needs.

In at least one implementation, the method 700 can further include compiling results on the effectiveness of the functional advertisement. In particular, compiling results on the effectiveness of the functional advertisement includes determining the number of users that interacted with the functional advertisement. For example, the method 700 can include determining the number of users currently online that interacted with the functional advertisement. Additionally or alternatively, the method 700 can include determining the demographics of users that interacted with the functional advertisement or determining the geographic locations of users that interacted with the functional advertisement.

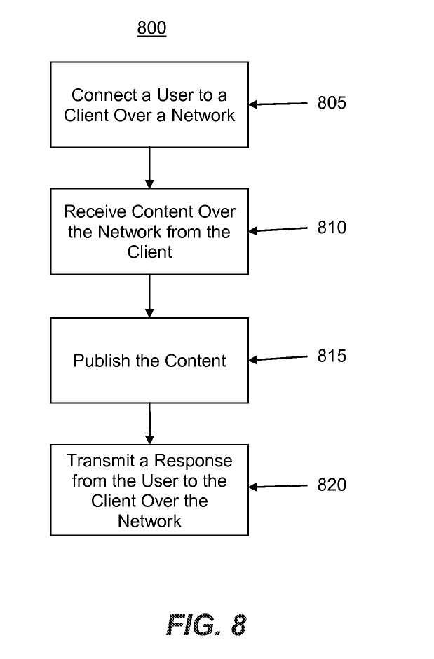

FIG. 8 is a flow chart illustrating an alternative method 800 for providing functional advertisements to a user. In at least one implementation, the method 800 can be implemented using computer-readable media on a user's multimedia device. One skilled in the art will appreciate that the method 800, as described herein, can be implemented in the systems of FIG. 1 and FIG. 2. Nevertheless, the method 800 is not limited to the systems of FIG. 1 and FIG. 2 but can be implemented in any system.

FIG. 8 shows that the method 800 includes connecting a user to a client over a network 805. In at least one implementation, the client is an individual or organization who presents content over the network. For example, the client can include a radio or television broadcaster. Additionally or alternatively, the client can include a chat moderator or any other individual who is controlling the amount and type of content presented to a user. In at least one implementation, the user is a consumer of the content presented by the client. For example, if the client is a radio broadcaster, a user is one who listens to the radio broadcast.

FIG. 8 also shows that the method 800 includes receiving content over the network from the client 810. In at least one implementation, the content includes real-time content. Specifically, the content can include a broadcast or other ephemeral content that is meant to be converted by a system into a sensory signal rather than being saved by the system, such as an audio broadcast. One skilled in the art will appreciate that the real-time content can be saved by the user, whether the intent is to be consumed in real-time or not. In particular, the content can include an audio component, even if the content includes other material. For example, a television broadcast includes an audio and video component. Additionally or alternatively, the content can include text, video, graphics or any other type of content.

In at least one implementation, the content also includes a functional advertisement. In particular, the a functional advertisement can be related to the real-time content if sent during or coincident with the real-time broadcast. For example, a radio station can broadcast live from a store and the functional advertisement can include material about the store, such as maps to the store or coupons that can be redeemed at the store. In at least one implementation, the functional advertisement can allow a user to respond to the client. For example, the client can publish a contest and allow the user to respond with an appropriate response. Additionally or alternatively, the user can forward the functional advertisement to other users or save the functional advertisement.

Additionally or alternatively, the functional advertisement can allow the user to compete with other users for prizes. For example, a score prediction contest can allow the user to compete with other users to guess what the final score of an upcoming sporting event. In at least one implementation, the prizes can be provided by the client. Additionally or alternatively, the client can sell the rights to the contest to a sponsor who would then provide the prizes in return for the exposure the sponsor receives.

FIG. 8 further shows that the method 800 includes publishing the content 815. In at least one implementation, publishing the content 815 includes converting an electrical signal, either digital or analog, to a sensory signal that can be perceived by the user. For example, publishing the content 815 can include converting the content to an audio signal in the speaker. Additionally or alternatively, publishing the content 815 can include converting the content to graphics on the monitor. One skilled in the art will appreciate that publishing the content 815 includes any conversion of the content which allows the content to be perceived by the user.

FIG. 8 also shows that the method 800 includes transmitting a response from the user to the client over the network 820. It at least one implementation, the response from the user can include a response to a specific request from the client for certain information. Additionally or alternatively, the response from the user can include information regarding the user's use of the functional advertisement, such as whether it was immediately deleted, forwarded or saved. One of skill in the art will appreciate that any response which allows the client to incorporate feedback regarding the user's use of the functional advertisement is within the scope of the method.

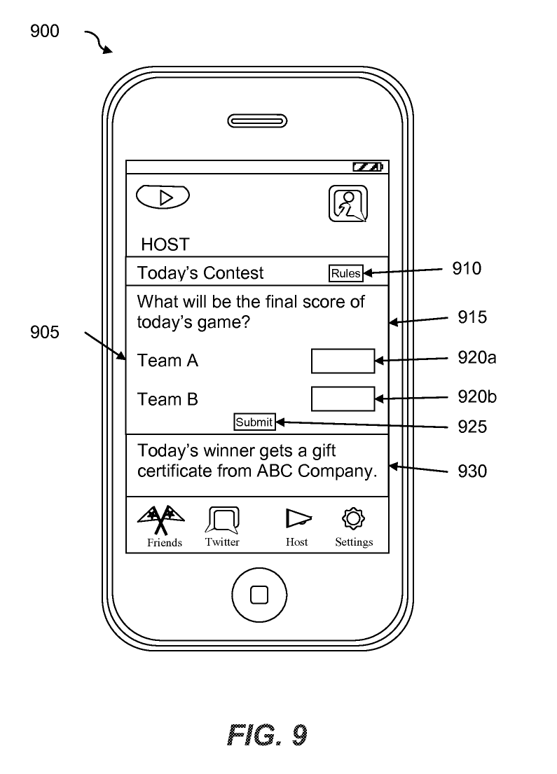

FIG. 9 illustrates an example of a client application 900 for providing a functional advertisement 905 to a user. In at least one implementation, the functional advertisement 905 can include a graphic. For example, the graphic can include a video file that is configured to be converted to an image on the user's device. Additionally or alternatively, the graphic can include an audio file that is configured to be converted to an audio signal on the user's device. For example, the functional advertisement 905 can include a game for the user to play, such as a score prediction contest.

FIG. 9 shows that the client application 900 can include a button 910 that allows users to obtain the rules of the contest if the functional advertisement 905 is a contest. For example, the rules can outline the time before which the response must be submitted, what to do in the case of a tie, who is eligible to enter the contest and the like.

Additionally or alternatively, the rules can include a software license agreement. In at least one implementation, a software license agreement is a contract between the “licensor” and purchaser of the right to use software. The license may define ways under which the software can be used, in addition to the automatic rights of the buyer. In particular, the software license agreement can be presented in digital form, and only presented to a user as a click-through where the user must “accept”. A software license agreement can also include end-user license agreements (EULAs).

FIG. 9 further shows that the client application 900 can include a frame 915 that presents the contest question to the user. For example, the contest question can include a score prediction contest or a trivia question. In at least one implementation, the frame 915 can include one or more boxes 920a and 920b (collectively “boxes 920”) that allows a user to enter an answer. Additionally or alternatively, the frame 915 can include possible answers if the question is a multiple-choice question.

FIG. 9 also shows that the frame 915 can include a submit button 925 which allows the user to submit their answer to the question. In at least one implementation, the submit button 925 can remain inactive until the user has entered a value into the boxes 920. Additionally or alternatively, there can be a submit button 925 next to multiple-choice answers which allow the user to simultaneously enter and submit their preferred answer.

FIG. 9 further shows that the client application 900 can include a space 930 that gives more details about the contest. For example, the space 930 can include details about prizes for winning the contest. Additionally or alternatively, the client can seek a contest sponsor or advertiser that pays to place an advertisement in the space 930. For example, the client could approach a sponsor who provides the prizes and other benefits of the game. In return, the sponsor can produce an ad or other content to fill the space 930.

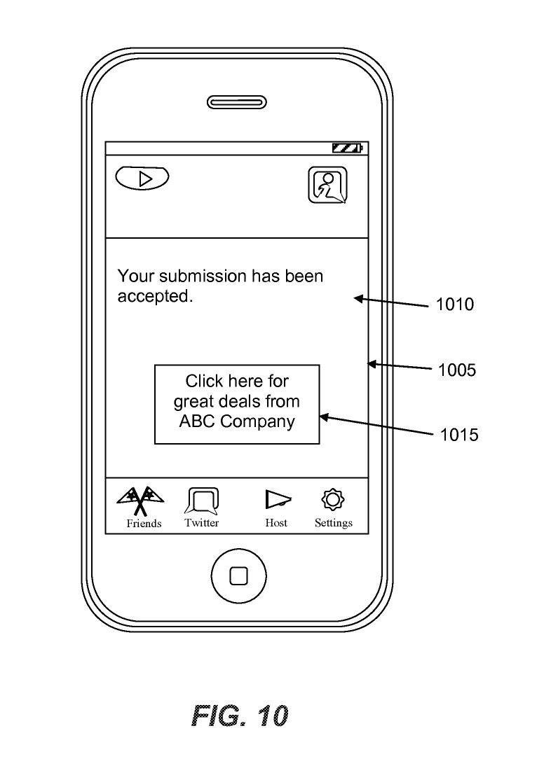

FIG. 10 illustrates an example of the functional advertisement 1005 of FIG. 9 after manipulation by the user. In at least one implementation, the functional advertisement can include an acknowledgement 1010 of the user's submission. In particular, the acknowledgement 1010 can indicate to the user that the submitted answer was accepted. For example, the acknowledgement 1010 can indicate to the user provided responses that were properly formatted and that the submission occurred within the allowed time period. Additionally or alternatively, the acknowledgement 1010 can indicate to the user that they have not duplicated the answer of another user.

FIG. 10 shows that the functional advertisement 1005 can include further advertisements 1015 from the client or sponsor. In at least one implementation, the advertisement 1015 can include a banner ad that links to a website maintained by the client or sponsor running the functional advertisement. Additionally or alternatively, the advertisement 1015 can give information about special deals that are available to the user for connecting to the sponsor through the client.

### III. Social Networking

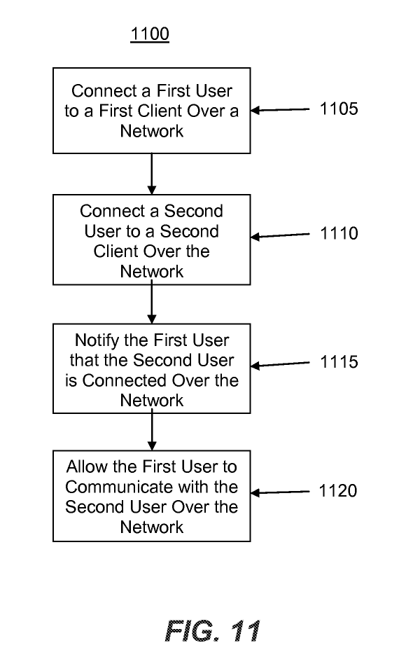

FIG. 11 is a flow chart illustrating an example method 1100 for providing a social networking experience for a user. In at least one implementation, a social network service focuses on building and reflecting of social networks or social relations among people, e.g., who share interests and/or activities. In particular, a social network service can consist of a representation of each user (often a profile), his/her social links, and a variety of additional services. Most social network services are network based and provide means for users to interact over the internet, such as e-mail and instant messaging. Although online community services are sometimes considered as a social network service in a broader sense, social network service usually means an individual-centered service whereas online community services are group-centered. Social networking sites can allow users share ideas, activities, events, and interests within their individual networks.

In at least one implementation, social networking includes social media. In particular, social media is the interaction of one user to another media designed to be disseminated through social interaction, created using highly accessible and scalable publishing techniques. Social media can take many different forms, including Internet forums, weblogs, social blogs, microblogging, wikis, podcasts, pictures, video, rating and social bookmarking. Technologies include: blogs, picture-sharing, vlogs, wall-postings, email, instant messaging, music-sharing, crowdsourcing, and voice over IP, to name a few. In particular, social media can use Internet and web-based technologies to transform broadcast media monologues (one to many) into social media dialogues (many to many). Social media can allow users to create, as well as consume, media content.

FIG. 11 shows that the method 1100 includes connecting a first user to a first client over a network 1105. In at least one implementation, connecting a first user to a first client includes producing a network connection between a device being used by the first client and a device being used by the first user. The connection can allow content to be directed in one-way or two-way traffic or can be used to limit the type of traffic that travels in a particular direction. For example, the connection can allow the client to publish information to the user as graphics, video or text but allow the user to respond using only text. The device used by the user can include any device capable of connecting to a network, such as a multimedia device, a computer, a cell phone or any other device that provides the necessary connection.

FIG. 11 also shows that the method 1100 includes connecting a second user to a second client over the network 1110. In at least one implementation, the second client can include the first client. Additionally or alternatively, the second client can be different than the first client. Allowing different users to connect to different clients over the same network can allow the users to interact with one another even if connected to different clients. For example, if the second user is identified as a friend of the first user then the first user could interact with the second user, even if both are connected to a different client.

In at least one implementation, the second user can be identified as a friend of the second user by creating a friends list for the first user. For example, the client application could allow the first user to build a friends list by searching for or otherwise identifying other users with who they have a relationship. Additionally or alternatively, the client application could import a friends list from another social networking application, from an e-mail list, from cell phone contacts or from some other source. For example, the client application could allow the user to import a friends list from Facebook. One of skill in the art will appreciate that the client application could allow a combination of methods for identifying other users as friends of the first user.

FIG. 11 further shows that the method 1100 includes notifying the first user that the second user is connected over the network 1115. In at least one implementation, the notifying the first user that the second user is connected over the network 1115 includes maintaining a list of friends using the network indicating to the user which are connected and which are offline. Additionally or alternatively, notifying the first user that the second user is connected over the network 1115 includes a pop-up message or other type of affirmative notification that alerts the first user that the second user has connected to the network. In at least one implementation, notifying the first user that the second user is connected over the network 1115 can include identifying the second user's geographic location relative to the first user's geographic location

FIG. 11 also shows that the method 1100 includes allowing the first user to communicate with the second user over the network 1120. In at least one implementation, allowing the first user to communicate with the second user over the network 1120 includes allowing the first user to exchange messages with the second user. For example, the client application could allow the user to send text messages to the second user. Additionally or alternatively, allowing the first user to communicate with the second user over the network 1120 includes allowing the first user to speak with the second user, send video to the second user, send an audio clip to the second user or send other type of content to the second user.

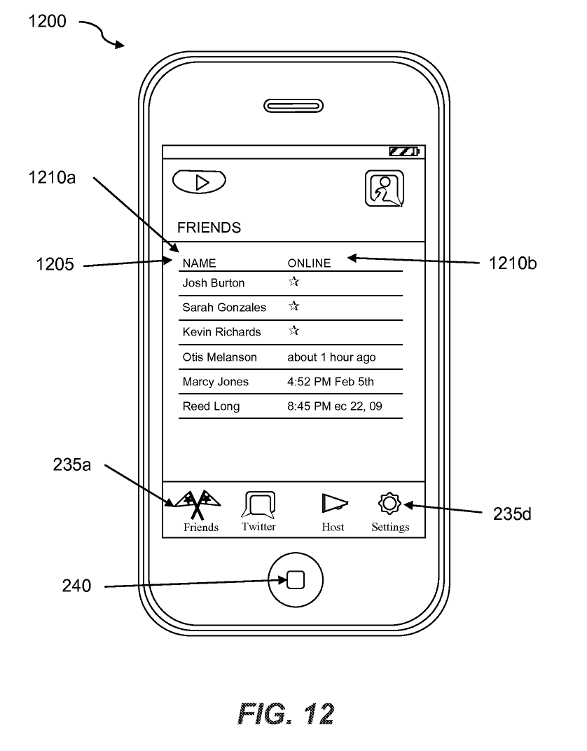

FIG. 12 illustrates an example of a client application 1200 for connecting a first user to other users. In at least one implementation, a first user can be alerted automatically when other users who have been identified as a friend are connected over the network. For example, when the first user connects to a client over the network, the client application 1200 can alert the first user whether other friends are connected. Additionally or alternatively, the first user can be alerted when friends connect or disconnect from the network.

FIG. 12 shows that the client application 1200 can allow the first user to select a friends tab 235a that allows the first user to check whether friends or other connections are online. In at least one implementation, the friends tab 235a can be accessed at any time, as the user desires. Additionally or alternatively, the tab 235a can change color or give other indicators if the status of one or more of the first user's friends has changed. In at least one implementation, the first user can change the settings using the settings tab 235d to receive the desired type of notification. One of skill in the art will appreciate that any method or type of notification can be provided to the user.

FIG. 12 also shows that the first user can be presented with a list 1205 of recent activities by the first user's friend. In at least one implementation, the list 1205 can include the most recent activity. For example, the list 1205 can include the status updates of the last six friends to either sign-in or sign-out of the network. Additionally or alternatively, the list 1205 can be selected to include one or more friends as identified by the first user.

FIG. 12 further shows that the list 1205 can include one or more pieces of information about the friends on the list 1205. In particular, the list 1205 can include one or more columns 1210a and 1210b (collectively “columns 1210”) which provide information about the friends on the list. For example, the first column 1210a can include the friends name or other identifier; e.g., a screen name or user id. Additionally, the second column 1210b can contain information about when the user's friends were last connected to the network. Additional columns 1210 could be added that present other information. For example, a column 1210 could indicate which types of messages the user is currently able to receive. Additionally or alternatively, a column 1210 could indicate the clients to which the user's friends have connected.

In at least one implementation, the friends list 1205 can allow the user to select a friend to communicate with over the network. In particular, the user can select a friend from the list 1205. The user can select the friend to communicate by scrolling through the list using the control 240 or through some other method, such as by using touch-screen technology. In at least one implementation, when the user selects the friend a new window can open that allows the user to enter a message to send to the friend. Additionally or alternatively, a window can open that allows the user to select from multiple options; e.g., block the friend, send a message, get additional information about the friend or other options.

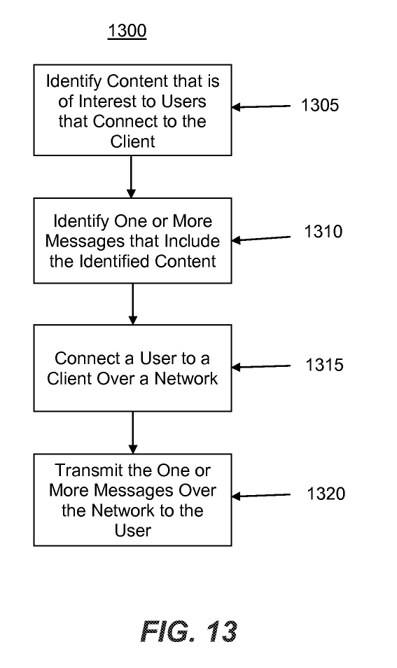

FIG. 13 is a flow chart illustrating an example method 1300 for providing a social media experience for a user. In at least one implementation, a social media experience allows a user to both create and consume media. In particular, the social media experience can allow the user to connect to a client with other users that have similar interests in the client or the client's product. For example, the social media experience can allow the user to view messages or news related to a favorite sports team.

FIG. 13 shows that the method 1300 includes identifying a topic that is of interest to users that connect to the client 1305. In particular, the client can identify one or more topics that would be of interest to users who seek to connect to the client. For example, a client which is a sports team can identify sports news, team schedules, injury reports, scores or other information that would be of interest to fans of the team. The client can look at users behavior to identify topics, can seek to identify topics itself or can allow users to suggest topics that are of interest.

In at least one implementation, the method 1300 includes identifying a tag within the network that relates to the topic. In at least one implementation, the tag can include text that identifies the topic. For example, the tag can be the client's name or other identifying information. Additionally or alternatively, the tag can include a non-hierarchical keyword or term assigned to a piece of information (such as an internet bookmark, digital image, or computer file). In particular, one or more tags can help describe an item and allow it to be found again by browsing or searching.

In at least one implementation, identifying a tag within the network that relates to the topic can include identifying hash tags. In at least one implementation, a hash tag can include a tag added by the composer of the message. In particular, a hash tag can include a hash (#) or other symbol added to text within the message which identifies the message as relating to a particular subject. Additionally or alternatively, the tag can be added automatically by the program used to compose the message. For example, users of Twitter can create messages, called tweets. The composer of the tweet can add a hash tag to the tweet or the user can use a client application to create the tweet and the client application can automatically add a hash tag to the tweet.

In at least one implementation, tags added by the client application used to compose a message can include metadata. In particular, metadata can include a means to describe the data files retrieved primarily by electronic form. For example, metadata can include information about a certain item's content, including: means of creation, purpose of the data, time and date of creation, creator or author of data, placement on a network where the data was created, what standard was used to create the message or other data to help identify the message. For instance, the metadata for an image file can contain information about how large the picture is, the color depth, the image resolution, when the image was created, and other data. A text document's metadata could contain information about how long the document is, who the author is, when the document was written, and a short summary of the document.

FIG. 13 further shows that the method 1300 includes identifying one or more messages that include the identified content 1310. In at least one implementation, identifying one or more messages that include the identified content 1310 can include identifying the one or more messages though the use of an index that stores messages based on the tags used in the message. Additionally or alternatively, the tag can be identified by running a search which looks through a group of messages to locate the tag being searched.

FIG. 13 also shows that the method 1300 includes connecting a user to a client over a network 1315. In at least one implementation, connecting a user to a client includes producing a network connection between a device being used by the client and a device being used by the user. The connection can allow content to be directed in one-way or two-way traffic or can be used to limit the type of traffic that travels in a particular direction. For example, the connection can allow the client to publish information to the user as graphics, video or text but allow the user to respond using only text. The device used by the user can include any device capable of connecting to a network, such as a multimedia device, a computer, a cell phone or any other device that provides the necessary connection.

FIG. 13 further shows that the method 1300 includes transmitting the one or more messages over the network to the user 1320. In at least one implementation, the user can select some or all of the messages to be transmitted. For example, if the user connects to the client over a network which charges based on the amount of data transmitted, the user may desire to forego downloading certain messages that are of less interest or that can be downloaded at another time when data charges will not apply.

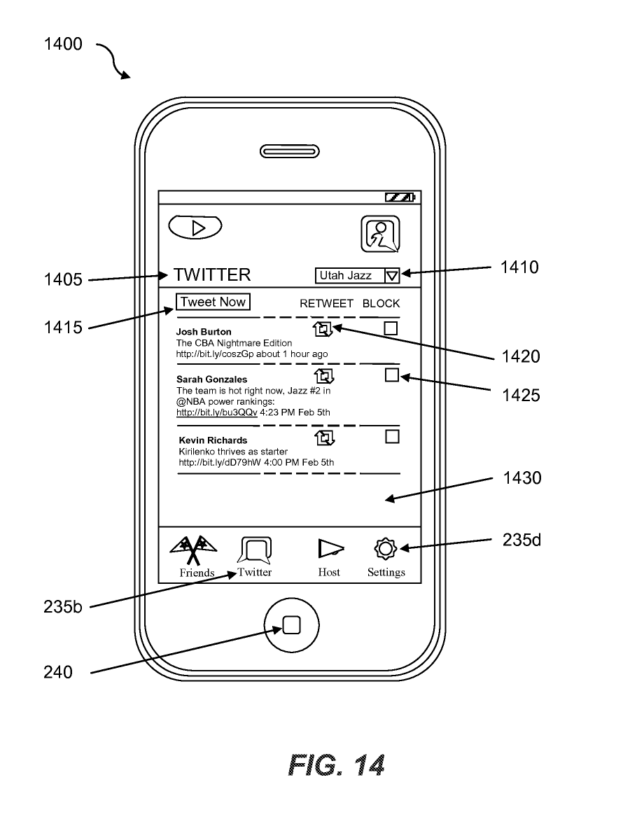

FIG. 14 illustrates an example of a client application 1400 providing a social media experience for a user. In at least one implementation, the social media experience can include producing and consuming media that are related to a specific subject. In particular, the social media experience can allow a user to view messages created by other users and to create messages that other users can view. For example, the user can view messages that relate to a specific topic, rather than messages that originate from a known user. That is, the user can connect to a client and view messages from other users that connect to the same client, rather than messages that come from identified friends of the user.

FIG. 14 shows that the user can locate messages about the desired topic using Twitter or a related service. In at least one implementation, the client application can display the name or logo of the message service such as name 1405. In particular, the user can select to view the desired tweets using tab 235b. The user can select the tab 235b using the control 240 or through the use of a touch-screen device. One of skill in the art will appreciate that although Twitter is being shown as an example of a messaging service, the user can use any messaging service that allows the transmission of messages of any type, whether textual, video, audio or any other type.

FIG. 14 also shows that the user can select a topic to which any displayed messages will relate. For example, the user can use a drop down menu 1410 which allows the user to select the topic to view. Additionally or alternatively, the drop down menu 1410 can include additional clients that the user can connect to over the network. For example, the user cold wish to follow multiple sports teams. The drop down menu 1410 could allow the user to switch among clients to which the user has previously connected.

FIG. 14 further shows that the client application 1400 can allow the user to compose one or more messages. In at least one implementation, the user can select a button, such as button 1415, which take the user to a screen where the user can compose or create a message. In particular, the button 1415 can allow the user to compose a message to which the client application 1400 will append the appropriate tags based on the topic selected using the drop down menu 1410.

FIG. 14 also shows that the client application 1400 can include a button 1420 that allows the user to resend a message as if they had composed it. In particular, the client application can allow the user to resend the message so that others who look at messages from them, i.e., are followers of the user rather than the original poster, can view the message as well. Additionally or alternatively, the button 1420 can format the message to give appropriate credit to the original author. For example, the button 1420 can prepare a message with quotation marks and the name of the original author. Additionally or alternatively, the button 1420 can create a message that includes a link to the original message.

FIG. 14 further shows that the client application 1400 can allow the user to block messages 1425. In at least one implementation, the user can block messages 1425 based on the author of the message. Additionally or alternatively, the user can block messages 1425 based on offensive words or images contained in the message. The author can use the option to block messages 1425 or can select the settings tab 235d to block messages based on certain criteria.

FIG. 14 also shows that the client application 1400 can include a blank space 1430 made available to the client to fill. In at least one implementation, the client can use the blank space 1430 to include information that would be relevant to users. Additionally or alternatively, the client can use the blank space 1430 for the addition of one or more advertisements. The advertisements can be created by the client or the client can sell the blank space 1430 as advertising space.

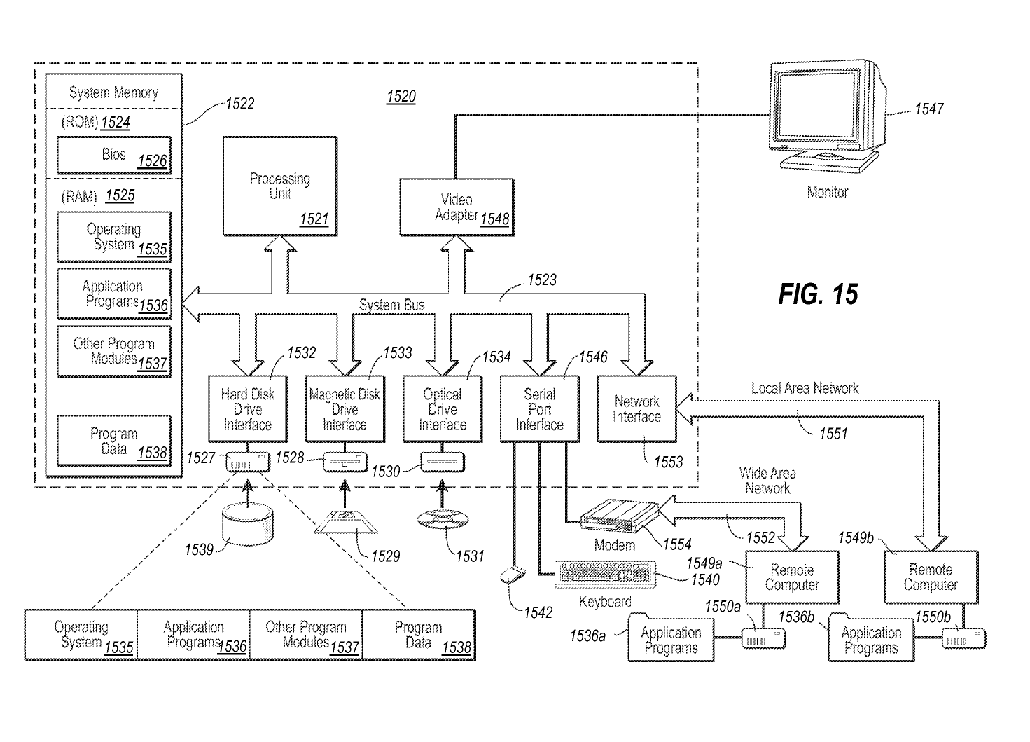

FIG. 15, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 15, an example system for implementing the invention includes a general purpose computing device in the form of a conventional computer 1520, including a processing unit 1521, a system memory 1522, and a system bus 1523 that couples various system components including the system memory 1522 to the processing unit 1521. It should be noted however, that as mobile phones become more sophisticated, mobile phones are beginning to incorporate many of the components illustrated for conventional computer 1520. Accordingly, with relatively minor adjustments, mostly with respect to input/output devices, the description of conventional computer 1520 applies equally to mobile phones. The system bus 1523 may be any of several types of bus structures including a memory bus or memory controller, a peripheral bus, and a local bus using any of a variety of bus architectures. The system memory includes read only memory (ROM) 1524 and random access memory (RAM) 1525. A basic input/output system (BIOS) 1526, containing the basic routines that help transfer information between elements within the computer 1520, such as during start-up, may be stored in ROM 1524.

The computer 1520 may also include a magnetic hard disk drive 1527 for reading from and writing to a magnetic hard disk 1539, a magnetic disk drive 1528 for reading from or writing to a removable magnetic disk 1529, and an optical disc drive 30 for reading from or writing to removable optical disc 1531 such as a CD-ROM or other optical media. The magnetic hard disk drive 1527, magnetic disk drive 1528, and optical disc drive 1530 are connected to the system bus 1523 by a hard disk drive interface 1532, a magnetic disk drive-interface 1533, and an optical drive interface 1534, respectively. The drives and their associated computer-readable media provide nonvolatile storage of computer-executable instructions, data structures, program modules and other data for the computer 1520. Although the exemplary environment described herein employs a magnetic hard disk 1539, a removable magnetic disk 1529 and a removable optical disc 1531, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 1539, magnetic disk 1529, optical disc 1531, ROM 1524 or RAM 1525, including an operating system 1535, one or more application programs 1536, other program modules 1537, and program data 1538. A user may enter commands and information into the computer 1520 through keyboard 1540, pointing device 1542, or other input devices (not shown), such as a microphone, joy stick, game pad, satellite dish, scanner, or the like. These and other input devices are often connected to the processing unit 1521 through a serial port interface 1546 coupled to system bus 1523. Alternatively, the input devices may be connected by other interfaces, such as a parallel port, a game port or a universal serial bus (USB). A monitor 1547 or another display device is also connected to system bus 1523 via an interface, such as video adapter 1548. In addition to the monitor, personal computers typically include other peripheral output devices (not shown), such as speakers and printers.

The computer 1520 may operate in a networked environment using logical connections to one or more remote computers, such as remote computers 1549a and 1549b. Remote computers 1549a and 1549b may each be another personal computer, a server, a router, a network PC, a peer device or other common network node, and typically include many or all of the elements described above relative to the computer 1520, although only memory storage devices 1550a and 1550b and their associated application programs 1536a and 1536b have been illustrated in FIG. 15. The logical connections depicted in FIG. 15 include a local area network (LAN) 1551 and a wide area network (WAN) 1552 that are presented here by way of example and not limitation. Such networking environments are commonplace in office-wide or enterprise-wide computer networks, intranets and the Internet.

When used in a LAN networking environment, the computer 1520 is connected to the local network 1551 through a network interface or adapter 1553. When used in a WAN networking environment, the computer 1520 may include a modem 1554, a wireless link, or other means for establishing communications over the wide area network 1552, such as the Internet. The modem 1554, which may be internal or external, is connected to the system bus 1523 via the serial port interface 1546. In a networked environment, program modules depicted relative to the computer 1520, or portions thereof, may be stored in the remote memory storage device. It will be appreciated that the network connections shown are exemplary and other means of establishing communications over wide area network 1552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment that includes an application for connecting a remote user to a client, a method of providing functional advertisements to the user, the method comprising:
providing a functional advertisement, wherein the functional advertisement includes an advertisement that the user can interact with;
connecting a user to the client over a network; and
transmitting the functional advertisement from the client to a user over the network.

2. A method according to claim 1, wherein the functional advertisement is configured to be published as an image.

3. A method according to claim 2, wherein the image includes blank space that is configured to be filled by the client.

4. A method according to claim 1, wherein the blank space to be filled by the client includes blanks space for the client to sell to a sponsor.

5. A method according to claim 1, wherein the functional advertisement includes a game for the user to play.

6. A method according to claim 5, wherein the game includes a score prediction contest.

7. A method according to claim 6, wherein the method further includes receiving a user's response, wherein receiving a user's response includes receiving the user's score prediction.

8. A method according to claim 7, wherein the method further includes transmitting the results of the score prediction contest to the user.

9. A method according to claim 5, wherein the game includes one of:
an outcome prediction contest; or
a player performance prediction contest.

10. A method according to claim 5, wherein the game includes one of:
a scored game, wherein the user competes with other users based on the high score of each user; or
a geographic game, wherein the user must visit one or more geographic locations.

11. A method according to claim 1, wherein the method further includes compiling results on the effectiveness of the functional advertisement.

12. A method according to claim 11, wherein compiling results on the effectiveness of the functional advertisement includes determining the number of users that interacted with the functional advertisement.

13. A method according to claim 11, wherein compiling results on the effectiveness of the functional advertisement includes one of:
determining the number of users currently online that interacted with the functional advertisement;
determining the demographics of users that interacted with the functional advertisement; or
determining the geographic locations of users that interacted with the functional advertisement.

14. A computing system comprising a processor and memory which stores one or more computer-executable components that when executed by the processor perform the following steps to provide functional advertisements:
connecting a user to a client over a network, wherein the user has utilized a multimedia device to connect to the network;
transmitting real-time content over the network to the user, wherein the real-time content is configured to be published by the multimedia device as:
an audio signal; or
an image;
transmitting a functional advertisement from the client to the user, wherein:
the functional advertisement is configured to be published by the multimedia device; and
the functional advertisement is configured to be manipulated by the user; and
receiving a response from the user.

15. A system according to claim 14, wherein the functional advertisement is related to the content of the real-time content.

16. A system according to claim 14, wherein the real-time content is transmitted only to users within a defined geographic area.

17. A system according to claim 14, wherein the functional advertisement is transmitted only to users within a defined geographic area.

18. A system embodied on a computer-readable storage medium bearing computer-executable instructions that, when executed by a processor operatively coupled to memory on a computer that includes a client application for communicating with a remote computer, carries out a method for providing functional advertisements to a user, the system comprising:
a processor;
a monitor, wherein the monitor is configured to display graphics to a user;
a speaker, wherein the speaker is configured to produce an audio signal that can be heard by the user; and
one or more computer readable media, wherein the one or more computer readable media contain a set of computer-executable instructions, the set of computer-executable instructions configured to:
connect a user to a client over a network;
wherein the client is an entity which presents content over the network;
wherein the user is a consumer of the content presented by the client;
receive the content over the network from the client, wherein the content includes:
real-time content, wherein the real-time content is intended to be consumed by the user at reception; and
functional advertisements, wherein:
the functional advertisement can be manipulated by the user; and
the functional advertisement allows the user to compete with other users for one or more prizes;
publish the content, wherein publishing the content includes:
converting the content to an audio signal in the speaker; or
converting the content to graphics on the monitor; and
transmit a response from the user to the client over the network.

19. A system according to claim 18, wherein the functional advertisement is transmitted at a pre-scheduled point in the real-time content.

20. A system according to claim 18, wherein the functional advertisement is transmitted at a point in the real-time content determined at the discretion of the client.
